(19) United States
(12) Patent Application Publication
(10) Pub. No.: US 2021/0209126 A1
(43) Pub. Date: Jul. 8, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masato ANDO, Kanagawa (JP); Hirokazu MUKAI, Kanagawa (JP); Tomoyuki ITO, Kanagawa (JP)

(73) Assignee: FUJI XEROX CO., LTD., Tokyo (JP)

(21) Appl. No.: 16/920,738

(22) Filed: Jul. 5, 2020

(30) Foreign Application Priority Data
Jan. 7, 2020 (JP) 2020-000870

(51) Int. Cl. G06F 16/27; G06F 16/28

(52) U.S. Cl. CPC G06F 16/27; G06F 16/288

(57) ABSTRACT

An information processing apparatus includes a processor. The processer is configured to detect a change of an item in a first relation diagram generated by systematically connecting plural items in accordance with relations of the items, and output information about the detected change to a second relation diagram that is associated with the first relation diagram in which the change is detected, the second relation diagram including an item that is determined to be identical to the item for which the change is detected.

### CROSS-REFERENCE TO RELATED APPLICATIONS

This application is based on and claims priority under 35 USC 119 from Japanese Patent Application No. 2020-000870 filed Jan. 7, 2020.

### BACKGROUND

### (i) Technical Field

The present disclosure relates to an information processing apparatus and a non-transitory computer readable medium.

### (ii) Related Art

Japanese Unexamined Patent Application Publication No. 2016-081185 describes a disclosure of an information processing apparatus. The information processing apparatus includes an acceptance unit, a deployment unit, and an output unit. A relation diagram is created by systematically connecting plural function items in accordance with dependence relations of the function items, each of the plural function items representing a function related to quality function deployment. Among the plural function items, a function item representing a function belonging to any of plural processes in the quality function deployment is provided with attribute information for identifying the process to which the function item belongs. Upon the relation diagram being input, the acceptance unit extracts, from the relation diagram, information for identifying the function item, the attribute information provided for the function item, and dependence information for identifying the dependence relations between the function items and accepts them as raw information. The deployment unit classifies the function items according to the process on the basis of the attribute information in the raw information, creates deployment information used for deploying the classified function items for each process, and deploys, on the basis of the deployment information, the raw information into a deployment chart in which the function items are deployed and in which the processes are axes. The output unit outputs the deployment chart deployed by the deployment unit.

### SUMMARY

A relation diagram displaying logical relations between elements is constituted by a section of same elements as those of other relation diagrams and a section of different elements from those of other relation diagrams. In a case where plural relation diagrams include the same element, if each of the relation diagrams is displayed or edited, it may be difficult to display or edit the relation diagrams in synchronization with each other as the relation diagrams increases.

Aspects of non-limiting embodiments of the present disclosure relate to an information processing apparatus and a non-transitory computer readable medium by which, if an element in a relation diagram is changed, it becomes easier to grasp a corresponding element in other relation diagrams than in a case where relation diagrams are independently edited.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processer is configured to detect a change of an item in a first relation diagram generated by systematically connecting plural items in accordance with relations of the items, and output information about the detected change to a second relation diagram that is associated with the first relation diagram in which the change is detected, the second relation diagram including an item that is determined to be identical to the item for which the change is detected.

### BRIEF DESCRIPTION OF THE DRAWINGS

An exemplary embodiment of the present disclosure will be described in detail based on the following figures, wherein:

FIG. 1 schematically illustrates a configuration of an information processing system according to the exemplary embodiment;

FIG. 2 is a block diagram illustrating a hardware configuration of a server;

FIG. 3 is a block diagram illustrating an example of a functional configuration of the server;

FIG. 4 illustrates a data structure example of a relation diagram information table;

FIG. 5 illustrates a data structure example of an item information table;

FIG. 6 illustrates a data structure example of a relation line information table;

FIG. 7 is a flowchart illustrating a flow of a relation diagram editing process performed by the server;

FIG. 8 illustrates an example of a user interface provided by the server;

FIG. 9 illustrates an example of the user interface provided by the server;

FIG. 10 illustrates an example of the user interface provided by the server;

FIG. 11 illustrates an example of the user interface provided by the server;

FIG. 12 illustrates an example of the user interface provided by the server;

FIG. 13 illustrates an example of the user interface provided by the server; and

FIG. 14 illustrates an example of the user interface provided by the server.

### DETAILED DESCRIPTION

Hereinafter, an example of an exemplary embodiment of the present disclosure will be described with reference to the attached drawings. Note that identical or equivalent components and sections are denoted by the same reference numerals in the drawings. In addition, the dimensional ratios in the drawings may be different from the actual ratios by being exaggerated for convenience of description.

First, the background to the exemplary embodiment of the present disclosure that the inventors have arrived at will be described.

Typically, in a system using complex physical phenomena, many events are linked to each other in a chained manner. For example, an effect, such as a final quality of a product, may be caused by plural events, which are caused by plural other events, and the plural other events are caused by plural still other events. In such a complex system, a large number of qualities need to be assured, and cause-and-effect relations between designs and qualities are extremely complex. Accordingly, it is difficult to find a design item that assures a desired quality, and a change in design value for assuring a certain quality may tend to adversely affect the other qualities.

To visualize and organize such complex cause-and-effect relations, relation information is used. The relation information refers to information in which causes and cause-and-effect relations between the causes are defined. An example of the relation information is a relation diagram representing the cause-and-effect relations by connecting effects and their causes to each other via relation lines. An example of the relation diagram is a logic tree. The relation diagram is suitably used to indicate effects and their causes in detail without any missing or overlapping item.

Another example of the relation information is a quality function deployment chart representing relations between events listed on plural axes that intersect with each other, by using symbols or numeric values arranged in a matrix. The quality function deployment chart represents cause-and-effect relations in a matrix in which some events are extracted from among many events and arranged on axes. Thus, relations between many effects and many causes may be represented simply.

However, if a relation diagram includes too many target events, the diagram becomes excessively complex and large. In addition, the quality function deployment chart is incapable of representing detailed cause-and-effect relations including events that are not arranged on axes, and as a result, items tend to be missing.

In a typical, widely used quality function deployment chart, causes and effects are arranged on two axes, the horizontal axis and the vertical axis, and is incapable of including information about the reasons for the indicated relations. However, it is useful to use a multi-axis quality function deployment chart representing overall cause-and-effect relations in which three or more axes are arranged to intersect with one another and some causes are extracted and illustrated from among the causes constituting the cause-and-effect relations.

From the above description, by using both a relation diagram and a multi-axis quality function deployment chart, it is possible to extract and illustrate cause-and-effect relations in detail without any missing or overlapping item, while simply displaying the relations between many causes and many effects. However, it is complicated to convert a relation diagram into a multi-axis quality function deployment chart or to convert a multi-axis quality function deployment chart into a relation diagram, and a system that supports the conversion is necessary.

In a case where a two-axis quality function deployment chart is to be displayed by depicting a relation diagram having hierarchical cause-and-effect relations and selecting a level therefrom, in order to create a hierarchical relation diagram, the cause-and-effect relations need to be originally organized in a hierarchical manner. Unless the cause-and-effect relations are originally organized in a hierarchical manner, it is difficult to depict hierarchical cause-and-effect relations in detail without any missing or overlapping item, which is the purpose of the disclosure. Even if causes are classified as hierarchy, display of all causes in a selected level in the quality function deployment chart increases the information amount to be displayed, which hinders the purpose to extract and display some causes.

The disclosure disclosed in Japanese Unexamined Patent Application Publication No. 2016-081185 proposes deployment of a quality function deployment chart after selecting an event corresponding to each axis of the quality function deployment chart on a created relation diagram. In this technique, however, information of the relation diagram is condensed to create a quality function deployment chart. This decreases information of the quality function deployment chart much less than information of the relation diagram. Thus, although it is possible to deploy the quality function deployment chart from the relation diagram, it is difficult in turn to reflect any changes of the quality function deployment chart in the relation diagram.

As described above, the relation diagram and the quality function deployment chart have different roles to visualize same cause-and-effect relations. Accordingly, it is desired, not only to use either one or to convert either one into the other in one way, but also to create and view both back and forth while keeping all information of complex cause-and-effect relations.

The relation diagram is not only created by a single user, and also different relation diagrams may be created by plural users. Relation diagrams created by plural users tend to include enormous elements and connectors in number. In this case, a user feels it difficult to recognize a section for the user or a section updated by another user, and thus, it is difficult to update and manage relation diagrams created by plural users. Text is edited concurrently by plural users by management of differences or by conversion in units of operation. However, it is difficult to edit a relation diagram displaying cause-and-effect relations of physical amounts by plural users by the same method for text because each relation diagram displays, in a dispersed manner, the same elements as those in other relation diagrams and different elements from those in other relation diagrams.

Accordingly, this exemplary embodiment will describe a technique by which, if associated relation diagrams are individually edited, a user is able to grasp a change in a relation diagram.

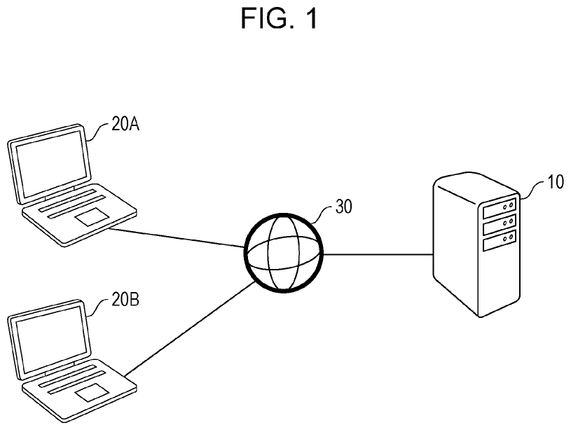

FIG. 1 schematically illustrates a configuration of an information processing system according to the exemplary embodiment. FIG. 1 illustrates a server 10 as an information processing apparatus and user terminals 20A and 20B.

The server 10 is an apparatus that outputs a relation diagram illustrating dependence relations between causes. The relation diagram represents dependence relations by linking function items via lines. In the exemplary embodiment, the server 10 has functions of receiving input regarding generation of relation diagrams from the user apparatuses 20A and 20B and generating relation diagrams in accordance with the received input. The user terminals 20A and 20B may receive the input regarding generation of different relation diagrams from users.

The exemplary embodiment is applicable to a relation diagram generating process for performing processing to obtain a relation diagram in quality function deployment. For example, in designing a product or a service, a design quality that satisfies customers is set, and in order to embody the set design quality, quality function deployment is applied to checking of dependence relations with the function items or components. In quality function deployment, it is necessary to check actual dependence relations properly, and thus, in quality function deployment, many function items such as a design quality are set accurately without any missing item (without any omission). In addition, in quality function deployment, one or more processes among a series of related processes are arranged on axes, function items (elements) of the processes are displayed systematically in a hierarchical manner, and thereby correspondence relations between the function items are clarified.

The exemplary embodiment is applied to generation of a relation diagram representing correspondence relations (dependence relations) between function items in two processes by combining correspondence relations between two related processes (e.g., correspondence relations in a deployment chart in which processes are arranged on axes) for quality function deployment of various cases. The generated relation diagram may be deployed as a two-element chart in quality function deployment. The two-element chart in quality function deployment may be any of various charts, such as a required quality deployment chart, a quality element (characteristics) deployment chart, a planned quality setting chart, a design quality setting chart, a function deployment chart, a mechanism deployment chart, a unit/component deployment chart, a method deployment chart, a new idea deployment chart, and a cost deployment chart. The two-element chart may further be any of various charts, such as a cost plan setting chart, a material deployment chart, a fault tree (FT) deployment chart, a reliability plan setting chart, a measurement equipment deployment chart, a measurement method deployment chart, a business function deployment chart, a technique deployment chart, a quality assurance (QA) chart, a quality control (QC) step chart, and an assured item deployment chart. The relation diagram generated according to the exemplary embodiment may be deployed as any of these charts. Without limitation to the above, the relation diagram generated according to the exemplary embodiment may be used for generating a two-element chart representing correspondence relations between desired processes.

Furthermore, the relation diagram generated according to the exemplary embodiment is applied to generation of a diagram for quality function deployment representing correspondence relations between function items in each process by combining correspondence relations between, not only two processes, but also three or more (e.g., three or four) processes. Note that in the following description, a diagram for quality function deployment representing correspondence relations between plural processes will be referred to as “multi-element chart”. That is, in the following description, a multi-element chart representing correspondence relations between two processes is referred to as a two-element chart, a multi-element chart representing correspondence relations between three processes is referred to as a three-element chart, and a multi-element chart representing correspondence relations between four processes is referred to as a four-element chart. In addition, in the exemplary embodiment, a process refers to a series of actions that relate to or act on each other for a target case, such as quality-performance-structure-material. Between related processes, an output of a process serves as an input for another (see, for example, JIS Q 9000).

Each of the user terminals 20A and 20B is an apparatus that is connected to the server 10 via a network 30, such as the Internet or an intranet, to receive input regarding generation of a relation diagram from a user. The user terminals 20A and 20B are used by different users. Although FIG. 1 illustrates two user terminals, the number of user terminals is not limited to a particular number in the information processing system. Each user terminal may be any apparatus having a function to be connected to the network 30, such as a personal computer, a smartphone, or a tablet terminal. In the following description, unless it is necessary to distinguish the user terminals 20A and 20B from each other, the user terminals 20A and 20B will be simply referred to as a user terminal 20.

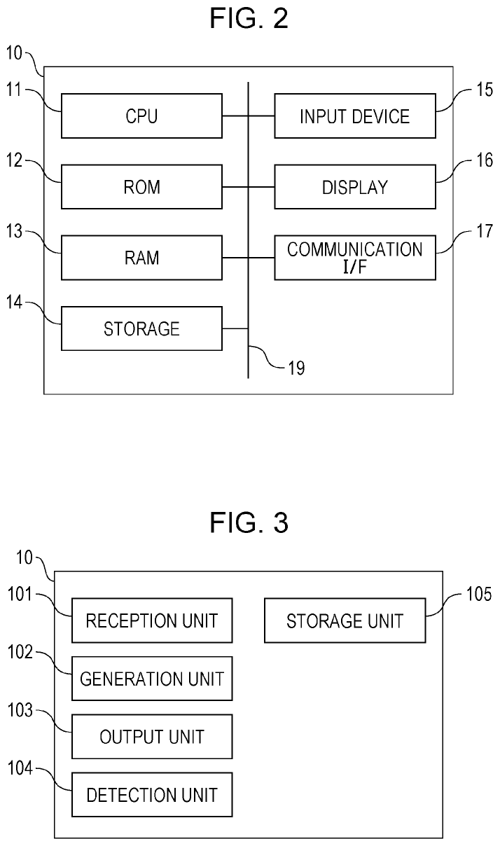

FIG. 2 is a block diagram illustrating a hardware configuration of the server 10.

As illustrated in FIG. 2, the server 10 includes a central processing unit (CPU) 11, a read only memory (ROM) 12, a random access memory (RAM) 13, a storage 14, an input device 15, a display 16, and a communication interface (I/F) 17. The components are connected to each other via a bus 19 to be able to communicate with each other.

The CPU 11 executes various programs or controls each unit. That is, the CPU 11 reads a program from the ROM 12 or the storage 14 and executes the program by using the RAM 13 as a work area. In accordance with the program recorded on the ROM 12 or the storage 14, the CPU 11 controls the above components and performs various arithmetic processes. In the exemplary embodiment, the ROM 12 or the storage 14 stores a relation diagram editing program by which a user may edit a relation diagram.

The ROM 12 stores various programs and various kinds of data. The RAM 13 temporality stores a program or data as a work area. The storage 14 is constituted by a storage device such as a hard disk drive (HDD), a solid state drive (SSD), or a flash memory, and stores various programs including an operating system and various kinds of data.

The input device 15 includes a pointing device, such as a mouse, and a keyboard and is used by a user to input various kinds of information.

The display 16 is, for example, a liquid crystal display and displays various kinds of information. The display 16 may also function as the input device 15 by employing a touch panel.

The communication interface 17 is an interface for communicating with other equipment such as a user terminal 20, and for example, a standard such as Ethernet (registered trademark), Fiber Distributed Data Interface (FDDI), or Wi-Fi (registered trademark) is used.

When executing the above relation diagram editing program, the server 10 implements various functions by using the above hardware resources. The functional configuration implemented by the server 10 will be described.

Next, the functional configuration of the server 10 will be described.

FIG. 3 is a block diagram illustrating an example of the functional configuration of the server 10.

As illustrated in FIG. 3, as the functional configuration, the server 10 includes a reception unit 101, a generation unit 102, an output unit 103, a detection unit 104, and a storage unit 105. Each function is implemented by the CPU 11 reading and executing the relation diagram editing program stored in the ROM 12 or the storage 14.

The reception unit 101 receives input regarding generation of a relation diagram from a user from a user terminal 20. The input regarding generation of a relation diagram includes various inputs regarding generation of a relation diagram such as setting of items, setting of attribute information for the items, linking between the items, and setting of processes for the items. The server 10 displays a user interface for generating a relation diagram on a screen of a user terminal 20. Information of a relation diagram, items, and relation lines is generated on a user interface of the user terminal 20 by a user operating keys on the keyboard, the mouse, or the like, and the reception unit 101 receives the information. In addition to reception of such information generated by the user operating keys on the keyboard or the like, the reception unit 101 may also, for example, read information stored in a hard disk (including, in addition to one built in a computer, one connected via a network).

The generation unit 102 generates a relation diagram on the basis of input received by the reception unit 101. The relation diagram is generated on the basis of the information received by the reception unit 101. For example, in accordance with a user editing operation received by the reception unit 101, the generation unit 102 edits items (including addition, deletion, and the like), edits attributes of the items (e.g., item names, characteristics, and the like), rearranges relation lines (including addition, deletion, and the like), and edits attributes of the relation lines (e.g., strength, direction, and the like). In addition, in accordance with a user operation on a screen displayed by the output unit 103, the generation unit 102 displays a new item and another item at different positions separately or at the same position in an integrated manner. The other item has substantially the same attributes as the new item and is already present at a position different from the position of the new item in a relation diagram.

The output unit 103 outputs the relation diagram generated by the generation unit 102. The relation diagram is output to the user terminal 20 that has received input regarding generation of a relation diagram from a user. In addition, the output unit 103 stores information about the relation diagram generated by the generation unit 102 in the storage unit 105.

The detection unit 104 detects a change of content of the relation diagram generated by the generation unit 102. The change of content includes change of an item name, addition/change/deletion of attribute information of an item, change/deletion of a relation line linking between items, change/deletion of setting of a process for an item, and the like. Then, the output unit 103 outputs information about the change detected by the detection unit 104.

For example, the output unit 103 outputs information about a change to a relation diagram. The relation diagram is associated with another relation diagram that is generated by the generation unit 102 and for which a change of content is detected by the detection unit 104. The relation diagram includes an item determined to be identical to the item for which a change is detected.

The storage unit 105 stores various kinds of information about operations of the server 10. In the exemplary embodiment, the storage unit 105 stores information about a relation diagram. For example, the storage unit 105 stores a relation diagram information table, an item information table, and a relation line information table. Herein, examples of the information about a relation diagram stored in the storage unit 105 will be described.

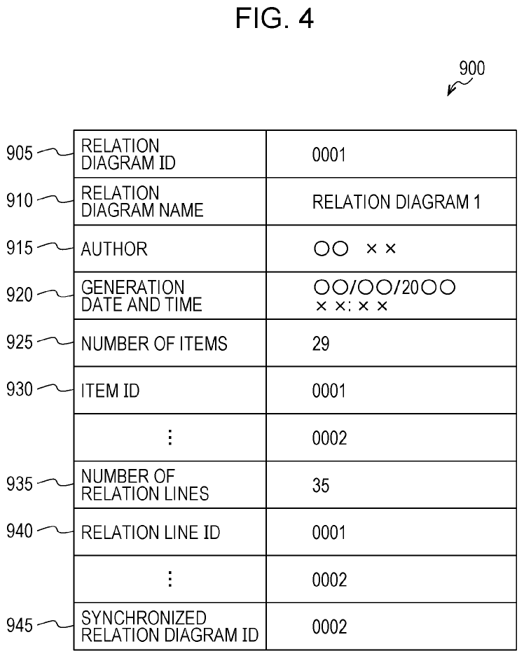

FIG. 4 illustrates a data structure example of a relation diagram information table 900. The relation diagram information table 900 includes a relation diagram identifier (ID) cell 905, a relation diagram name cell 910, an author cell 915, a generation date and time cell 920, a number-of-items cell 925, item ID cells 930, a number-of-relation-lines cell 935, relation line ID cells 940, and a synchronized relation diagram ID cell 945. In the exemplary embodiment, the relation diagram ID cell 905 stores information (relation diagram ID) for uniquely identifying a relation diagram. The relation diagram name cell 910 stores a name of the relation diagram having the relation diagram ID. The author cell 915 stores an author of the relation diagram. The generation date and time cell 920 stores a date and time at which the relation diagram is generated or edited (year, month, day, hour, minute, second, decimal, or a combination thereof). The number-of-items cell 925 stores the number of items in the relation diagram. There are as many item ID cells 930 as the number of items indicated in the number-of-items cell 925 below the number-of-items cell 925. In the exemplary embodiment, the item ID cells 930 store information (item IDs) for uniquely identifying the items. The information indicated by the item IDs is stored in an item information table 1000. The number-of-relation-lines cell 935 stores the number of relation lines in the relation diagram. There are as many relation line ID cells 940 as the number of relation lines indicated in the number-of-relation-lines cell 935 below the number-of-relation-lines cell 935. In the exemplary embodiment, the relation line ID cells 940 store information (relation line IDs) for uniquely identifying the relation lines. The information indicated by the relation line IDs is stored in a relation line information table 1100. The synchronized relation diagram ID cell 945 stores an ID of a relation diagram synchronized with the above relation diagram.

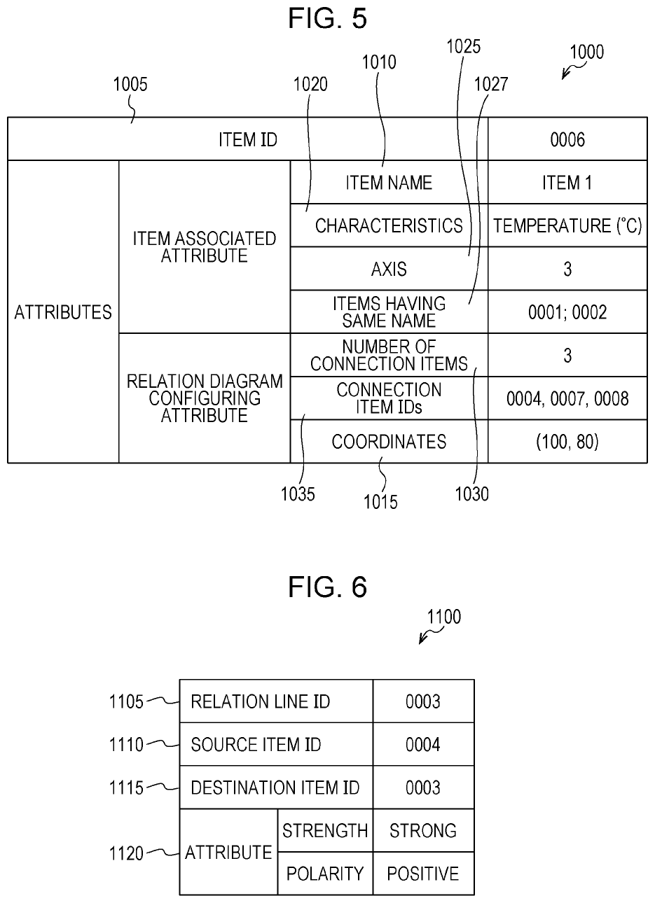

FIG. 5 illustrates a data structure example of the item information table 1000. The item information table 1000 is prepared for each item ID and includes, as attributes, an item associated attribute that is an attribute associated with an item and a relation diagram configuring attribute that is an attribute for configuring a relation diagram. The item associated attribute is attributes such as a name of an item, characteristics, and an axis to which the item belongs. Note that the characteristics herein include a nature, a behavior, and an effect. The relation diagram configuring attribute is attributes such as the number of connection items, connection item IDs, and coordinates. Along with the relation diagram configuring attribute, the item information table 1000 includes an item ID cell 1005, an item name cell 1010, a coordinates cell 1015, a characteristics cell 1020, an axis cell 1025, an item having same name cell 1027, a number-of-connection-items cell 1030, and a connection item ID cell 1035. The item ID cell 1005 stores an item ID. The item name cell 1010 stores a name of an item having the item ID. The coordinates cell 1015 stores coordinates at which the item is displayed in the relation diagram. The characteristics cell 1020 stores characteristics of the item. The axis cell 1025 stores an axis to which an axis item corresponding to the item belongs when the relation diagram is converted into a deployment chart. The item having same name cell 1027 stores information of items that are determined to be identical to the subject item, in the form of “relation diagram ID; item ID”. The number of pieces of the information is equal to the number of items that are determined to be identical to the subject item. Note that the items that are determined to be identical do not necessarily have completely the same name as the name of the subject item. The same items as the subject item may be designated by input from a user. The number-of-connection-items cell 1030 stores the number of items to which the subject item is connected. That is, the number-of-connection-items cell 1030 stores the total number of items serving as destinations of the item as a source and items serving as sources of the item as a destination. The connection item ID cell 1035 stores as many connection item IDs as the number of items indicated in the number-of-connection-items cell 1030. The connection item ID cell 1035 stores IDs of items serving as destinations and items serving as sources.

FIG. 6 illustrates a data structure example of the relation line information table 1100. The relation line information table 1100 includes a relation line ID cell 1105, a source item ID cell 1110, a destination item ID cell 1115, and an attribute cell 1120. The relation line ID cell 1105 stores a relation line ID of a relation line. The source item ID cell 1110 stores an item ID of an item serving as a source for the relation line. The destination item ID cell 1115 stores an item ID of an item serving as a destination for the relation line. The attribute cell 1120 stores an attribute of the relation line. The attribute is, for example, a polarity of the relation line. The polarity is a nature regarding whether an increase in a numeric value of an item serving as a source increases a numeric value of an item serving as a destination (e.g., in direct proportion) or whether an increase in a numeric value of an item serving as a source decreases a numeric value of an item serving as a destination (e.g., in reverse proportion). Also, the attribute is, for example, the strength of a degree of a relation indicated by the relation line or the direction of a relation indicated by the relation line.

Note that the tables illustrated in FIGS. 4 to 6 are examples, and other data structures may alternatively be used. For example, the data structure of a graph may be used.

The generation unit 102 is capable of generating a relation diagram visually representing dependence relations between items by using data stored in the tables illustrated in FIGS. 4 to 6.

In addition, information about a relation diagram is not necessarily stored in the storage unit 105. The relation information may be stored in an apparatus other than the server 10.

Next, operations of the server 10 will be described.

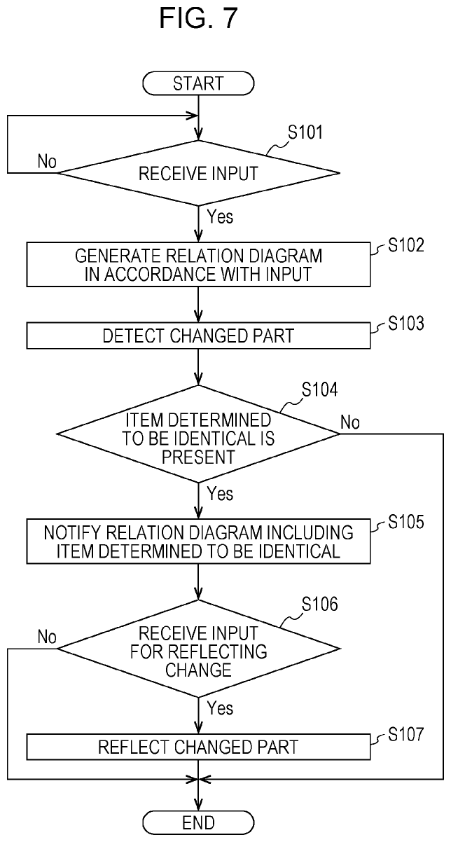

FIG. 7 is a flowchart illustrating a flow of a relation diagram editing process performed by the server 10. The relation diagram editing process is performed by the CPU 11 reading a relation diagram editing program from the ROM 12 or the storage 14 and loading and executing the program in the RAM 13.

First, the CPU 11 waits until receiving input regarding generation of a relation diagram from a user terminal 20 (step S101).

Upon input regarding generation of a relation diagram being received from the user terminal 20 (step S101; Yes), the CPU 11 generates a relation diagram in accordance with the input from the user terminal 20 (step S102). For example, if the input regarding generation of a relation diagram is setting of an item, the CPU 11 displays the item corresponding to the input in the relation diagram. For example, if the input regarding generation of a relation diagram is setting of attribute information for the item, the CPU 11 displays the attribute information corresponding to the input in a relation diagram or stores the attribute information in the item information table 1000. For example, if the input regarding generation of a relation diagram is linking between items, the CPU 11 displays a line linking between the items or stores information about linking between the items in the relation line information table 1100.

Subsequently to step S102, the CPU 11 detects a changed part in the editing-target relation diagram in units of items (step S103).

Subsequently to step S103, the CPU 11 determines whether the detected changed part includes an item that is determined to be identical to an item in another relation diagram (step S104). Referring to the item information table 1000 illustrated in FIG. 5, the CPU 11 determines whether the detected changed part includes an item that is determined to be identical to an item in another relation diagram.

Note that the CPU 11 may notify another relation diagram of a change in a certain relation diagram simply on the condition that an item name is the same. Also, the CPU 11 may notify another relation diagram of a change in a certain relation diagram if the following conditions are satisfied: an item name is the same and an item name related to the item is the same.

As a result of the determination in step S104, if the detected changed part includes an item that is determined to be identical to an item in another relation diagram (step S104; Yes), the CPU 11 notifies the other relation diagram including the item of the change (step S105). Referring to the item information table 1000 illustrated in FIG. 5, the CPU 11 determines whether the detected changed part includes an item that is determined to be identical to an item in another relation diagram. The notification in step S105 may be sent immediately when it is determined that the other relation diagram includes an item determined to be identical or may be sent when the other relation diagram including an item determined to be identical to the changed part is edited.

Subsequently to step S105, the CPU 11 determines whether input of a user operation for reflecting the change in the other relation diagram that is notified of the change is received from the user terminal 20 (step S106).

As a result of the determination in step S106, if input of a user operation for reflecting the change is received from the user terminal 20 (step S106; Yes), the CPU 11 reflects the changed part in the other relation diagram that is notified of the change (step S107).

As a result of the determination in step S104, if the detected changed part does not include an item that is determined to be identical to an item in another relation diagram (step S104; No), the CPU 11 skips the process in and after step S105.

As a result of the determination in step S106, if input of a user operation for reflecting the change is not received from the user terminal 20 (step S106; No), the CPU 11 skips the process in step S107.

By performing a series of operations illustrated in FIG. 7, when associated relation diagrams are individually edited, the server 10 makes it easier to grasp a change of an item in a relation diagram and a relation of a corresponding element in another relation diagram than in a case where relation diagrams are independently edited.

Next, examples of a user interface provided by the server 10 will be described.

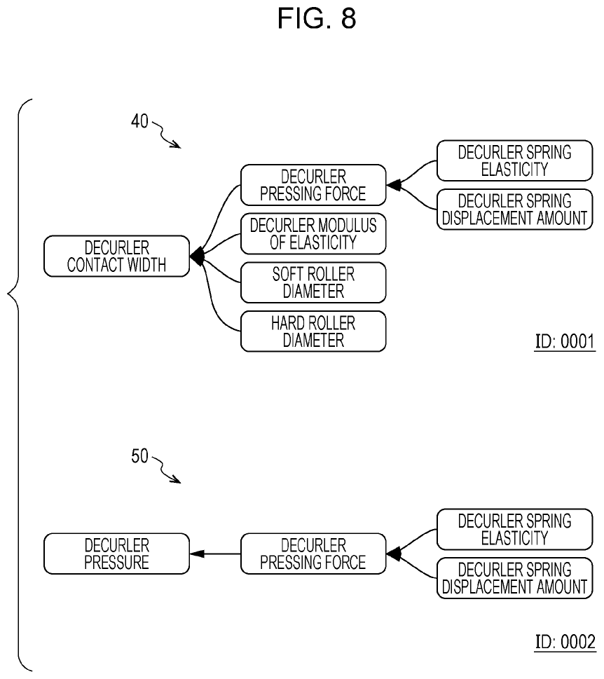

FIG. 8 illustrates an example of the user interface provided by the server 10. In FIG. 8, two relation diagrams 40 and 50 are illustrated in a drawing for convenience of description. However, the relation diagram 40 and the relation diagram 50 are independently edited. The relation diagram 40 is edited by the user terminal 20A, and the relation diagram 50 is edited by the user terminal 20B. The relation diagram 40 has a relation diagram ID of 0001, and the relation diagram 50 has a relation diagram ID of 0002. Data indicating that the relation diagrams 40 and 50 are synchronized with each other is stored in the relation diagram information table 900 of the server 10.

Although the relation diagram 40 and the relation diagram 50 are generated by focusing on different events, the relation diagram 40 and the relation diagram 50 include a common item “decurler pressing force”. Thus, the server 10 stores, in the item information table 1000 for the relation diagram 40, information indicating that “decurler pressing force” in the relation diagram 40 is an item identical to “decurler pressing force” in the relation diagram 50. Similarly, the server 10 stores, in the item information table 1000 for the relation diagram 50, information indicating that “decurler pressing force” in the relation diagram 50 is an item identical to “decurler pressing force” in the relation diagram 40. If the server 10 detects that a user edits the item “decurler pressing force” in either one of the relation diagram 40 and the relation diagram 50, the server 10 performs processing to notify the other that the user edits the item “decurler pressing force”.

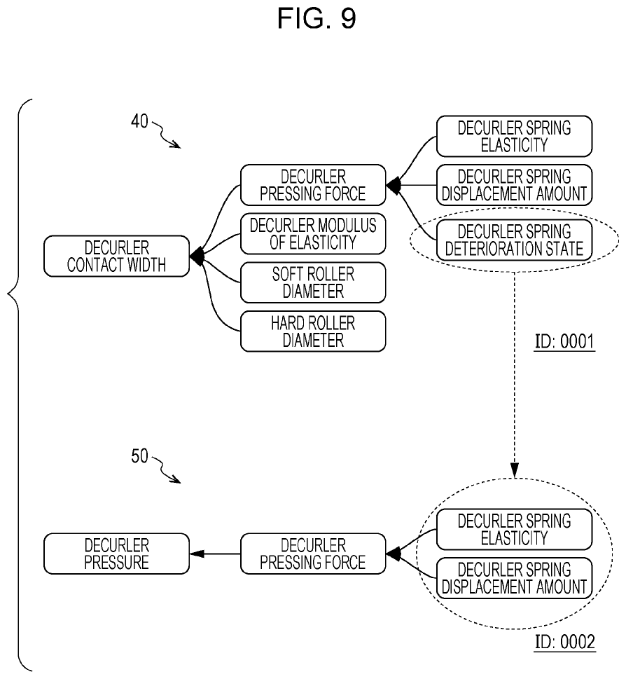

FIG. 9 illustrates an example of the user interface provided by the server 10. In FIG. 9, the two relation diagrams 40 and 50 are illustrated in a drawing for convenience of description as in FIG. 8. The relation diagram 40 is edited on the user terminal 20A, and an item “decurler spring deterioration state” is added as an item related to “decurler pressing force”. Upon detection of addition of the item “decurler spring deterioration state” as an item related to “decurler pressing force” in the relation diagram 40, the server 10 sends a notification about the addition of the item by a predetermined method.

For example, if the relation diagram 50 is opened on the user terminal 20B, the server 10 notifies the relation diagram 50 that the item “decurler spring deterioration state” is added as an item related to “decurler pressing force” in the relation diagram 40. Then, if the user terminal 20B receives input for reflecting the change in the relation diagram 50, the server 10 adds the item “decurler spring deterioration state” as an item related to “decurler pressing force” in the relation diagram 50.

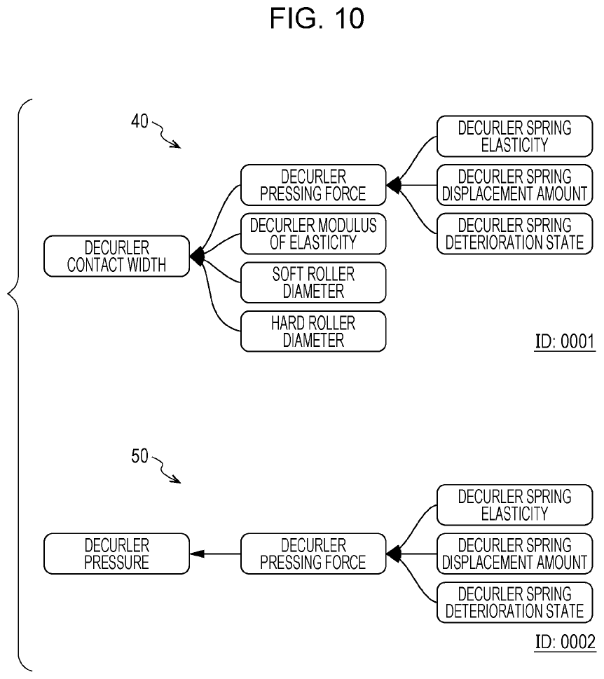

FIG. 10 illustrates an example of the user interface provided by the server 10. In FIG. 10, the two relation diagrams 40 and 50 are illustrated in a drawing for convenience of description as in FIG. 8 and FIG. 9. In FIG. 10, the item “decurler spring deterioration state” is added as an item related to “decurler pressing force” also in the relation diagram 50.

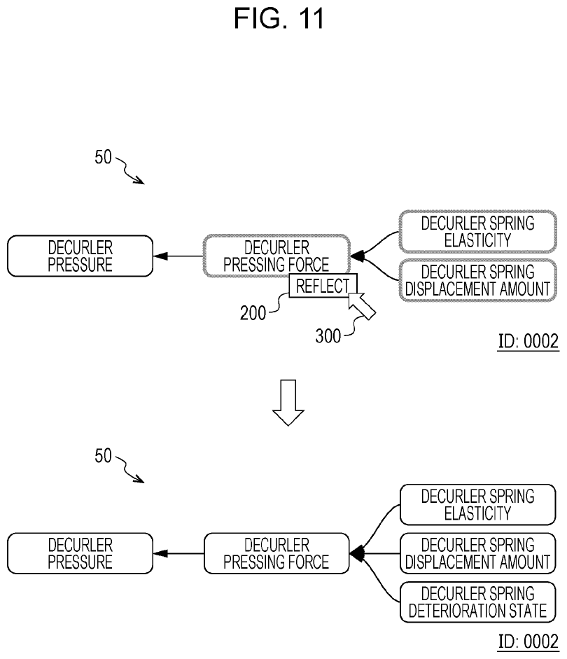

FIG. 11 illustrates an example of the user interface provided by the server 10. In FIG. 11, an example of a notification about a change in another relation diagram sent by the server 10 is illustrated.

Upon detection of addition of the item “decurler spring deterioration state” as an item related to “decurler pressing force” in the relation diagram 40, the server 10 notifies the relation diagram 50 of the change, when the relation diagram 50 is opened on the user terminal 20B, by, for example, changing color of frames of “decurler pressing force”, “decurler spring elasticity”, and “decurler spring displacement amount” to predetermined color. If a user operates a mouse cursor 300 to select the frame of “decurler pressing force”, the server 10 displays a menu 200 for reflecting the change to be superposed on the relation diagram 50. If a user operates the mouse cursor 300 to select the menu 200, the server 10, as illustrated in FIG. 11, adds the item “decurler spring deterioration state” as an item related to “decurler pressing force”. By the server 10 providing such a user interface, the user can grasp the change in the relation diagram 40 that is associated with the relation diagram 50.

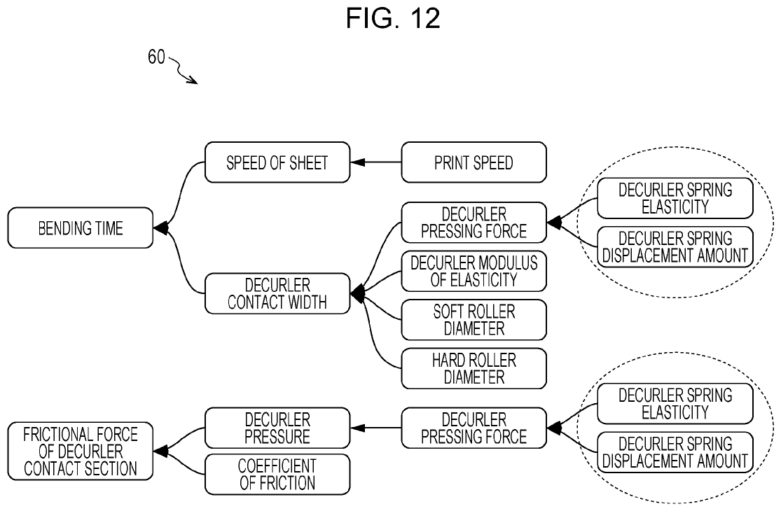

The server 10 may allow collective editing of plural relation diagrams. FIG. 12 illustrates an example of the user interface provided by the server 10. In FIG. 12, a relation diagram 60 obtained by combining the two relation diagrams 40 and 50 is illustrated. Thus, information indicating that the relation diagram 60 is associated with both the relation diagram 40 and the relation diagram 50 is registered in the relation diagram information table 900. By combining the two relation diagrams 40 and 50 into a single diagram, the item “decurler pressing force” appears at two positions in the relation diagram 60.

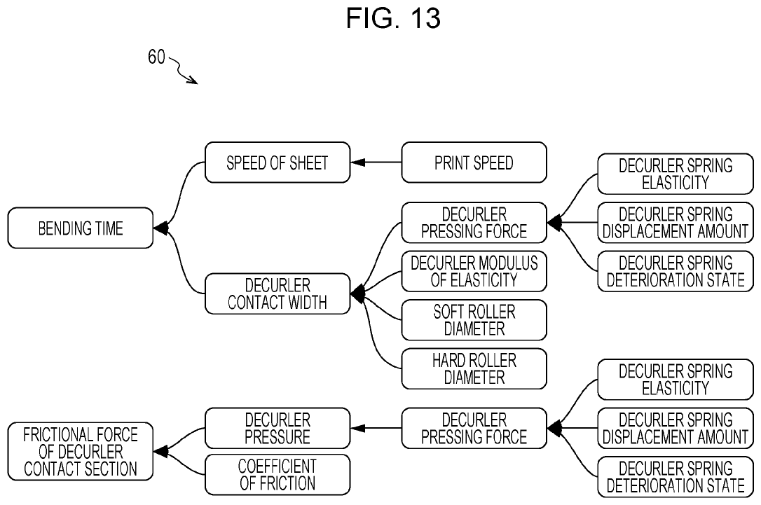

As described above, herein, the item “decurler spring deterioration state” is added as an item related to “decurler pressing force” in the relation diagram 40. The server 10 notifies the relation diagram 60 that the item “decurler pressing force” is edited. FIG. 13 illustrates an example of the user interface provided by the server 10. In FIG. 13, editing in the relation diagram 40 is reflected in the relation diagram 60. Thus, in FIG. 13, the item “decurler spring deterioration state” is added to “decurler pressing force” at two positions.

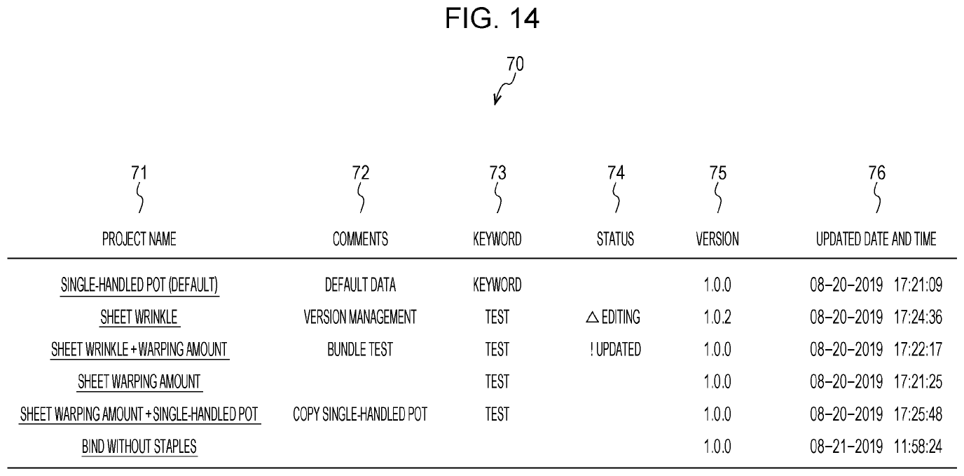

As a notification, when presenting a list of managing relation diagrams to a user terminal 20, the server 10 may present that an associated relation diagram is edited. FIG. 14 illustrates an example of the user interface provided by the server 10. In FIG. 14, a list 70 of relation diagrams managed by the server 10 is illustrated. The list 70 includes a project name cell 71 in which a title (project name) of a relation diagram is displayed, a comment cell 72 in which a comment for each relation diagram is displayed, a keyword cell 73 in which a keyword of each relation diagram is displayed, a state cell 74 in which the state of each relation diagram is displayed, a version cell 75 in which a version number of each relation diagram is displayed, and an update date and time cell 76 in which an update date and time of each relation diagram is displayed. The date and time for the update date and time cell 76 is obtained from the generation date and time cell 920 of the relation diagram information table 900.

Herein, “editing” is displayed in the state cell 74 for a relation diagram having a project name “sheet wrinkle” on a second row from the top of the list 70. This means that a person is currently editing the relation diagram.

In addition, “updated” is displayed in the state cell 74 for a relation diagram having a project name “sheet wrinkle+warping amount” on a third row from the top of the list 70. This means that an item determined to be identical in a relation diagram associated with the subject relation diagram is edited. Thus, when opening the relation diagram having the project name “sheet wrinkle+warping amount”, a user is able to know about a changed item from a notification from the server 10.

Although the exemplary embodiment describes a case where the program for the relation diagram editing process is stored (installed) in the ROM or the storage in advance. However, the disclosure is not limited to this. The program may be provided by being stored in a storage medium such as a Compact Disk Read Only Memory (CD-ROM), a Digital Versatile Disk Read Only Memory (DVD-ROM), or a Universal Serial Bus (USB) memory. Alternatively, the program may be downloaded via a network from an external apparatus.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
detect a change of an item in a first relation diagram generated by systematically connecting a plurality of items in accordance with relations of the items, and
output information about the detected change to a second relation diagram that is associated with the first relation diagram in which the change is detected, the second relation diagram including an item that is determined to be identical to the item for which the change is detected.

2. The information processing apparatus according to claim 1,
wherein the processor outputs information for explicitly indicating a part in the second relation diagram corresponding to a changed part.

3. The information processing apparatus according to claim 1,
wherein the processor displays, on a list of relation diagrams, information indicating a change in a part in the second relation diagram corresponding to a changed part.

4. The information processing apparatus according to claim 1,
wherein the processor outputs information about the detected change to a third relation diagram, the third relation diagram being obtained by combining the first relation diagram in which the change is detected and the second relation diagram.

5. The information processing apparatus according to claim 1,
wherein the first relation diagram in which the change is detected is generated by combining two or more relation diagrams.

6. The information processing apparatus according to claim 5,
wherein, upon detection of the change of the item in the first relation diagram, the processor outputs information about the detected change to each of the relation diagrams from which the first relation diagram is generated.

7. The information processing apparatus according to claim 1,
wherein the processor reflects the change in the second relation diagram if input of an instruction for reflecting the change is received.

8. The information processing apparatus according to claim 7,
wherein the input is made for at least part of the change.

9. The information processing apparatus according to claim 1,
wherein the processor determines an item in the second relation diagram to be identical to the item for which the change is detected in the first relation diagram if the items have identical names.

10. The information processing apparatus according to claim 9,
wherein the processor determines an item in the second relation diagram to be identical to the item for which the change is detected in the first relation diagram if, further, items related to the items have identical names.

11. A non-transitory computer readable medium storing a program causing a computer to execute a process for information processing, the process comprising:
detecting a change of an item in a first relation diagram generated by systematically connecting a plurality of items in accordance with relations of the items; and
outputting information about the detected change to a second relation diagram that is associated with the first relation diagram in which the change is detected, the second relation diagram including an item that is determined to be identical to the item for which the change is detected.

12. An information processing apparatus comprising:
processing means for: detecting a change of an item in a first relation diagram generated by systematically connecting a plurality of items in accordance with relations of the items; and outputting information about the detected change to a second relation diagram that is associated with the first relation diagram in which the change is detected, the second relation diagram including an item that is determined to be identical to the item for which the change is detected.
